(19) United States
(12) Patent Application Publication
(10) Pub. No.: US 2025/0326531 A1
(43) Pub. Date: Oct. 23, 2025

(54) POLYMERIC BAG WITH REINFORCING SEAL

(71) Applicant: Inteplast Group Corporation, Livingston, NJ (US)

(72) Inventor: Asmin T. Patel, Sanford, FL (US)

(21) Appl. No.: 19/185,837

(22) Filed: Apr. 22, 2025

Related U.S. Application Data
(60) Provisional application No. 63/637,714, filed on Apr. 23, 2024.

(51) Int. Cl. B65D 33/02; B31B 70/64; B31B 160/20; B65D 33/25

(52) U.S. Cl. CPC B65D 33/02; B31B 70/64; B65D 33/2508; B31B 2160/20

(57) ABSTRACT

A polymeric bag comprises front and rear walls, a bottom and top edge spaced apart along a bag length, and first and second side edges spaced apart along a bag width. The front and rear walls, bottom and top edges, and first and second side edges collectively define an interior compartment therebetween. A reclosable opening is disposed along the top edge to provide access to the interior compartment. The polymeric bag may have a side gusset(s) and/or a bottom gusset disposed at the side and bottom edges respectively. One or more reinforcing seals are disposed along the first and second side edges to seal a portion of at least one of the side gusset and bottom gusset. Each reinforcing seal has a length extending from the bottom edge toward the reclosable opening and a width extending from one side edge toward another.

### RELATED CASES

This application is the nonprovisional of U.S. Patent Application Ser. No. 63/637,714, entitled POLY MERIC BAG WITH REINFORCING SEAL, filed Apr. 23, 2024, the content of which are incorporated herein in its entirety.

### BACKGROUND

Plastic bags are commonly used for packaging purposes such as containing and transporting and goods. Accordingly, there are many different plastic bag designs for the wide array of applications for plastic bags. In general, plastic bags are typically formed of thin flexible layers of material joined into the structure design of the plastic bag.

### SUMMARY

Aspects of the present disclosure permit an improved framework for reinforcing plastic bags.

In one aspect, a reinforced polymeric bag comprises a bag front wall and a bag rear wall. A bag bottom edge and a bag top edge are spaced apart along a bag length. A bag first side edge and a bag second side edge are spaced apart along a bag width. The bag front wall, bag rear wall, bag bottom edge, bag first side edge, and bag second side edge collectively define an interior compartment therebetween. A reclosable opening is disposed along the bag top edge. The reclosable opening is configured to seal the bag top edge and unseal the bag top edge thereby providing access to the interior compartment. A first side gusset is disposed along the bag first side edge. A second side gusset is disposed along the bag second side edge. A first reinforcing seal is configured to seal at least a portion of the first side gusset. The first reinforcing seal is configured to reinforce the bag first side edge. The first reinforcing seal extends from the bag bottom edge toward the reclosable opening along a first reinforcing seal length. The first reinforcing seal extends from the bag first side edge toward the bag second side edge along a first reinforcing seal width. A second reinforcing seal is configured to seal at least a portion of the second side gusset. The second reinforcing seal is configured to reinforce the bag second side edge. The second reinforcing seal extends from the bag bottom edge toward the reclosable opening along a second reinforcing seal length. The second reinforcing seal extends from the bag second side edge toward the bag first side edge along a second reinforcing seal width.

In another aspect, a method of forming a reinforced polymeric bag generally comprises forming a bag including a front wall and a back wall so that the front and back wall are connected at least at some of peripheral edge margins of the front wall and back wall to form a space in the bag. The front and back walls are further sealed along at least one of the peripheral edge margins over a length that is less than a length of said one of the peripheral edge margins.

Other objects and features will be in part apparent and in part pointed out hereinafter.

### BRIEF DESCRIPTION OF THE DRAWINGS

FIG. 1 is an enlarged, fragmentary elevation of a plastic bag of the prior art.

FIG. 2 is an enlarged, fragmentary elevation of another plastic bag of the prior art.

FIG. 3 is a reinforced polymeric bag with first and second reinforcing seals, according to an embodiment.

FIG. 4 is an enlarged, fragmentary elevation of a reinforcing seal in a rough-textured pattern, according to an embodiment.

FIG. 5 is an enlarged, fragmentary elevation of a reinforcing seal in a cross-hatched pattern, according to an embodiment.

Corresponding reference characters indicate corresponding parts throughout the drawings.

### DETAILED DESCRIPTION

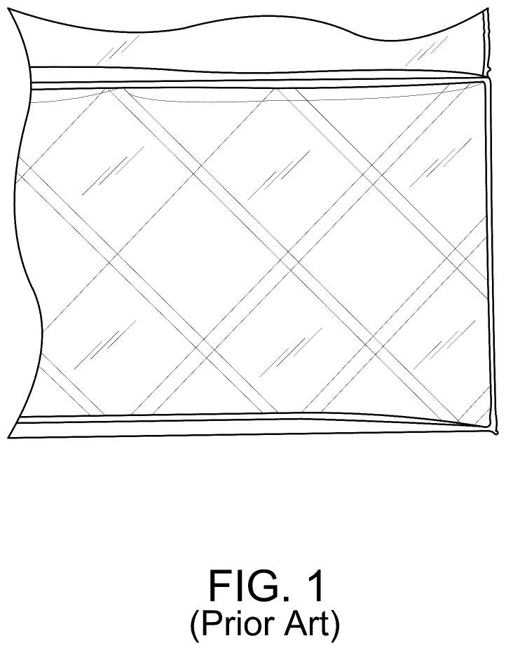

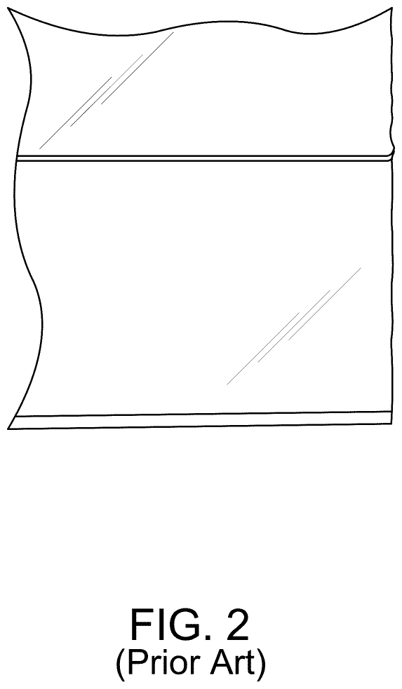

Plastic bags such as those shown in FIGS. 1 and 2 are commonly used to contain goods. Moreover, it is common for plastic bags to include gussets for increasing the capacity of the bags. One difficulty that the inventors have recognized with current configurations of plastic bags, is durability. With conventional plastic bags, there is generally a singular seal for sealing a side edge and gusset of the plastic bag. These plastic bags are more prone to breaking as the seals are not suitable for the increased bag capacity enabled by the gusset feature. However, the shortcomings of conventional plastic bags may be reduced by increasing the durability of plastic bags. It is to be understood that the reinforcing seal also has application for bags which do not have gussets. Accordingly, the present disclosure provides a reinforced polymeric bag configured to strongly support and contain goods therein.

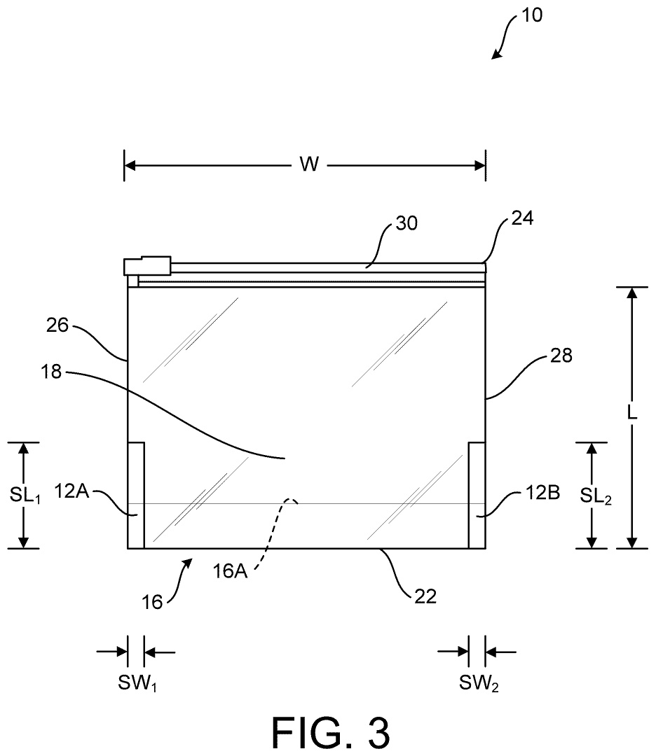

Referring now to FIG. 3, an exemplary embodiment of a reinforced polymeric bag in accordance with the present disclosure is generally indicated at reference number 10. Instead of using a single seal to seal a side edge and a gusset feature of a bag, the reinforced polymeric bag 10 employs reinforcing seals 12A, 12B to seal one or more gussets 16 of the reinforced polymeric bag. Furthermore, the reinforcing seals 12A, 12B provide the bag 10 with reinforcements to reduce the risk of bag-breakage. The individual features of the reinforced polymeric bag 10 will now be described in greater detail before turning to an exemplary method of forming the reinforced polymeric bag.

The reinforced polymeric bag 10 comprises a bag front wall 18 and an opposing bag rear wall (not shown but underlying the front wall 18 in FIG. 3). Moreover, the reinforced polymeric bag 10 comprises a bag bottom edge 22 and a bag top edge 24 spaced apart along a bag length L, and a bag first side edge 26 and bag second side edge 28 spaced apart along a bag width W. It will be apparent to a person of ordinary skill in the art, that the polymeric bag 10 may be shaped and arranged to accommodate a plurality of bag sizes to account for different applications of the bag.

The bag front wall 18, bag rear wall, bag bottom edge 22, bag first side edge 26, and bag second side edge 28 are joined to one another to collectively define an interior compartment therebetween for containing goods therein. A reclosable opening 30 is disposed along the bag top edge 24. The reclosable opening 30 spans across the entire bag width W to seal and unseal the bag top edge 24. In other words, the reclosable opening 30 is configured to seal the reinforced polymeric bag 10 to securely contain goods therein, and the reclosable opening is configured to unseal the bag 10 to provide access to the interior compartment. In the illustrated embodiment, the reclosable opening 30 comprises a zipper closure configured for sealing and unsealing the bag top edge 24, however it will be apparent to a person of ordinary skill in the art that other closure devices such as a push-to-close closure may be used as the reclosable opening without departing from the scope of the present disclosure.

The reinforced polymeric bag 10 may comprise at least one of a side gusset (not shown) and a bottom gusset 16 configured to increase the capacity of the reinforced polymeric bag 10. In an exemplary embodiment, the reinforced polymeric bag 10 comprises a first side gusset (not shown) disposed along the bag first side edge 26 and a second side gusset (not shown) disposed along the bag second side edge 28. In another embodiment, the reinforced polymeric bag 10 comprises the bottom gusset 16 disposed along the bag bottom edge 22. As is known, the gusset 10 is formed by folding the front wall 18 and back wall upwardly into the bag. A top edge of the gusset 16 is indicated by reference numeral 16A. The polymeric bag 10 formed in this way has four layers of polymeric material overlying one another below the top edge 16A of the gusset 16, and two layers of polymeric material overlying each other above the top edge. Similarly, the reinforced polymeric bag 10 may comprise both side gussets (not shown) and a bottom gusset 16. Moreover, the reinforced polymeric bag 10 may be configured without gussets entirely.

The first and second reinforcing seals 12A, 12B are configured to seal the gussets 16 to the reinforced polymeric bag 10 and reinforce seams of the bag. For example, when the reinforced polymeric bag 10 comprises bottom gusset 16, the first reinforcing seal 12A is configured to seal at least a portion of the bottom gusset 16 and reinforce the bottom gusset and the bag first side edge 26. The second reinforcing seal 12B is configured to seal at least a portion of the bottom gusset 16 and reinforce the bottom gusset and bag second side edge 28. The first and second reinforcing seals 12A, 12B are each configured to seal at least a portion of the bottom gusset. The first reinforcing seal 12A is configured to extend from the bag bottom edge 22 towards the reclosable opening 30 along a first reinforcing seal length SL₁. Moreover, the first reinforcing seal 12A is configured to extend from the bag first side edge 26 toward the bag second side edge along a first reinforcing seal width SW₁. The second reinforcing seal 12B is configured to extend from the bag bottom edge 22 towards the reclosable opening 30 along a second reinforcing seal length SL₂. Moreover, the second reinforcing seal 12B is configured to extend from the bag second side edge 28 toward the bag first side edge 26 along a second reinforcing seal width SW₂. In a preferred embodiment, the lengths SL₁, SL₂ are sufficiently great to extend from the bottom of the polymeric bag 10 to positions above the top edge 16A of the gusset 16. Stated another way, the first and second reinforcing seals 12A, 12B extend across the transition from four layers of material (within the gusset 16), to two layers of material (above the top edge 16A of the gusset). The lengths SL₁, SL₂ are less than the length of the side of the bag 10 along which the respective first and second reinforcing seal 12A, 12B extends. In other embodiments, the lengths SL₁, SL₂ are less than one quarter of the length of the side along which the respective first or second reinforcing seal 12A, 12B extends. However, in still other embodiments, the first and second reinforcing seals 12A, 12B may be used at the lower corners of a bag that does not have gussets. In either case, the first and second reinforcing seals 12A, 12B reinforce the bag against stress concentrations at the lower corners of the bags 10 and help to prevent leakage of water through small tears at the corners. The first and second reinforcing seals 12A, 12B may extend from a bottom corner of the polymeric bag 10 to a top corner of the polymeric bag.

In an exemplary embodiment, the first and second reinforcing seal lengths SL₁, SL₂ correspond to the bag length L, therefore the first and second reinforcing seals are configured to extend from the bag bottom edge 22 to the reclosable opening 30 along the entirety of the bag first and second side edges 26, 28. In the illustrated embodiment, the first and second reinforcing seal lengths SL₁, SL₂ extend only along a portion of the bag first and second side edges 26, 28. Furthermore, in the illustrated embodiment, the first and second reinforcing seal widths SW₁, SW₂ extend only along a portion of the bag bottom edge 22. In a preferred embodiment, the first and second reinforcing seal widths SW₁, SW₂ are in an inclusive range from ½ to 1 inch. Preferably, the widths SW₁, SW₂ are greater than a thickness of the polymeric material forming the front and back walls. In other embodiments (not shown), the widths SW₁, SW₂ are greater than a seal width used to connect the front and rear walls.

A method of forming the reinforced polymeric bag 10 is further described in detail below. In general, the method and materials for forming the reinforced polymeric bag 10 described herein are configured for forming a durable low-cost bag. For example, the method involves forming the reinforced polymeric bag 10 from a single piece of plastic film.

Initially, a manufacturer prepares the materials for forming the reinforced polymeric bag 10. For example, a tube of plastic film for forming the reinforced polymeric bag 10 is extruded. Next at least one of side gussets (not shown) and the bottom gusset 16 are optionally formed. In an exemplary embodiment, the first side gusset is formed by folding the tube lengthwise along first and second gusset fold lines to form the first side gusset therebetween. Similarly, the second side gusset is formed by folding the tube lengthwise along third and fourth gusset fold lines to form the second side gusset therebetween. In the illustrated embodiment, the tube is folded along bottom gusset fold lines to form the bottom gusset 16 therebetween.

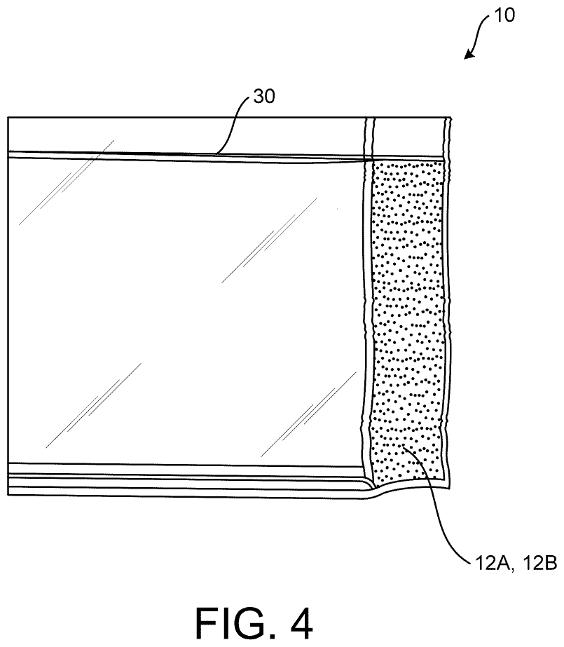

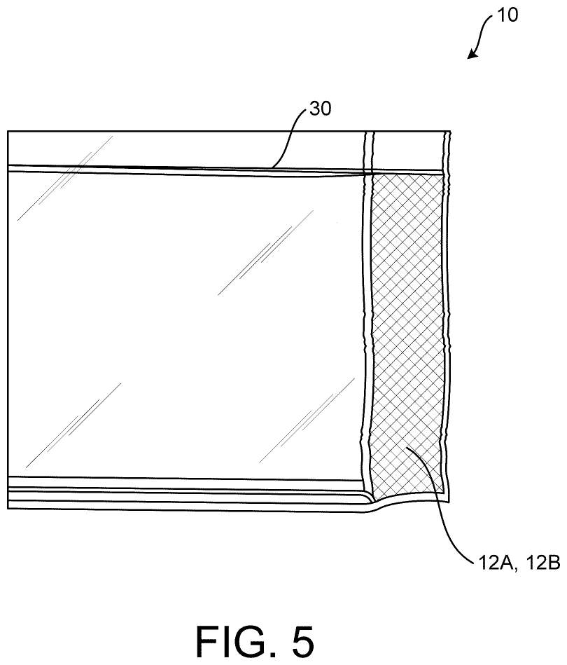

The first reinforcing seal 12A is formed to extend from the bag bottom edge 22 toward the bag top edge 24 along the first reinforcing seal length SL₁. The second reinforcing seal 12B is formed to extend from the bag bottom edge 22 toward the bag top edge 24 along the second reinforcing seal length SL₂. Moreover, the first reinforcing seal 12A is formed to extend from the bag first side edge 26 toward the bag second side edge 28 along the first reinforcing seal width SW₁, and the second reinforcing seal 12B is formed to extend from the bag second side edge 28 toward the bag first side edge 26 along the second reinforcing seal width SW₂. The seals can be formed in a suitable manner such as by applying heat, pressure and time to the layers of the film. Heat can be applied to the film layers using metal blocks or heads heated by heater rods, ultrasonic energy, hot air, etc. Pressure is applied by pressing the top and bottom heated blocks using pneumatic driver, a servo mechanism, ultrasonic horn and anvil, and in other ways known to those of ordinary skill in the art. In an exemplary embodiment, the first and second reinforcing seals 12A, 12B are formed in a pre-defined seal pattern. For example, the first and second reinforcing seals 12A, 12B are optionally formed in at least one of a rough-textured pattern (FIG. 4) and a cross-hatched pattern (FIG. 5). The use of the patterns prevents too much shrinkage of the reinforcing seal 12, 12B, particularly when high temperatures are used to bond the film layers together. Shrinkage can cause the bag to deform in ways that are aesthetically unpleasing to a consumer. The patterns also promote contact area in the case where the seal forming apparatus has metal to metal sealing heads, between which the film layers pass for sealing. Still further, the patterns draw attention to the seal, providing a visual que that a strong seal is present at this location.

The reclosable opening 30 is formed at a top opening of the tube to define the bag top edge 24. In one embodiment, forming the reclosable opening 30 involves forming a zipper closure at the top opening of the tube, such that the zipper closure is configured to seal and unseal the bag top edge 24. In another embodiment, forming the reclosable opening 30 involves forming a push-to-close closure at the top opening of the tube, such that the push-to-close closure is configured to seal and unseal the bag top edge 24. In the embodiments shown in FIGS. 4 and 5, the reinforcing seals 12A, 12B extend from a bottom corner to the reclosable opening 30.

In an exemplary embodiment, the method is similarly performed to form a plurality of the reinforced polymeric bags 10 from a tube of plastic film.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products without departing from the scope of the invention, it is intended that all matter contained in the above description and shown in the accompanying drawings shall be interpreted as illustrative and not in a limiting sense.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. A reinforced polymeric bag, comprising:
a bag front wall and a bag rear wall;
a bag bottom edge and a bag top edge spaced apart along a bag length;
a bag first side edge and a bag second side edge spaced apart along a bag width, the front wall and back wall being connected to each other at the side edges and a bottom edge of the bag so that the bag front wall, bag rear wall, bag bottom edge, bag first side edge, and bag second side edge collectively define an interior compartment therebetween;
a reclosable opening disposed along the bag top edge, the reclosable opening configured to seal the bag top edge and unseal the bag top edge thereby providing access to the interior compartment;
a first reinforcing seal configured to reinforce the first bag side edge, the first reinforcing seal extending from the bag bottom edge toward the reclosable opening along a first reinforcing seal length, the first reinforcing seal extending from the bag first side edge toward the bag second side edge along a first reinforcing seal width; and
a second reinforcing seal configured to reinforce the bag second side edge, the second reinforcing seal extending from the bag bottom edge toward the reclosable opening along a second reinforcing seal length, the second reinforcing seal extending from the bag second side edge toward the bag first side edge along a second reinforcing seal width.

2. The reinforced polymeric bag of claim 1, wherein the first and second reinforcing seal lengths correspond to the bag length.

3. The reinforced polymeric bag of claim 1, wherein the first and second reinforcing seal widths are in an inclusive range from ½ to 1 inch.

4. The reinforced polymeric bag of claim 1, wherein at least one of the first and second reinforcing seals are formed in a cross-hatched pattern.

5. The reinforced polymeric bag of claim 1, wherein at least one of the first and second reinforcing seals are formed in a rough-textured pattern.

6. The reinforced polymeric bag of claim 1, wherein the reclosable opening comprises a zipper-closure configured for sealing and unsealing the bag top edge.

7. The reinforced polymeric bag of claim 1, wherein the reclosable opening comprises a push-to-close closure configured for sealing and unsealing the bag top edge.

8. The reinforced polymeric bag of claim 1, further comprising a gusset is disposed along the bag bottom edge.

9. The reinforced polymeric bag of claim 8, wherein the first and second reinforcing seals are each configured to seal at least a portion of the bottom gusset.

10. The reinforced polymeric bag of claim 1 wherein at least one of the first and second reinforcing seals extends from a location within the gusset to a location outside the gusset.

11. The reinforced polymeric bag of claim 10 wherein said at least one of the first and second reinforcing seals extends across a transition of the bag within the gusset having four overlying layers of polymeric material to outside the gusset having two layers of polymeric material.

12. The reinforced polymeric bag of claim 1 wherein at least one of the first and second reinforcing seals extends from a bottom edge of the bag to the reclosable opening.

13. A method of forming a reinforced polymeric bag, comprising:
forming a bag including a front wall and a back wall so that the front and back wall are connected at least at some of peripheral edge margins of the front wall and back wall to form a space in the bag;
sealing the front and back walls at least one of the peripheral edge margins over a width that is greater than a thickness of polymeric material forming the front and back walls.

14. The method of claim 13 further comprising forming a gusset in at least one of the peripheral edge margins, and wherein sealing comprises forming a first reinforcing seal configured to extend from a location within the gusset to a location outside the gusset to a location outside the gusset.

15. The method of claim 14 wherein the first reinforcing seal is formed to extend from a bottom peripheral edge toward a top peripheral edge.

16. The method of claim 15 wherein the first reinforcing seal is formed to extend from the bottom peripheral edge to a closure opening of the bag.

17. The method of claim 14 wherein sealing further comprises forming a second reinforcing seal configured to extend from a location within the gusset to a location outside the gusset. 18 The method of claim 17, wherein sealing comprises forming the first reinforcing seal to extend from a bag first side edge toward a bag second side edge along a first reinforcing seal width in an inclusive range of ½ to 1 inch and wherein forming the second reinforcing seal to extend from the bag second side edge toward the bag first side edge along a second reinforcing seal width in an inclusive range of ½ to 1 inch.

19. The method of claim 17, further comprising forming at least one of the first and second reinforcing seals in a cross-hatched pattern.

20. The method of claim 17, further comprising forming at least one of the first and second reinforcing seals in a rough-textured pattern.
